(19) United States
(12) Patent Application Publication
(10) Pub. No.: US 2020/0364227 A1
(43) Pub. Date: Nov. 19, 2020

(54) DYNAMIC HANDLING OF SKEW TO DELIVER CONSISTENT RUNTIME PERFORMANCE FOR PREPARED QUERIES

(71) Applicant: Hewlett Packard Enterprise Development LP, Houston, TX (US)

(72) Inventor: Shine Mathew, Bangalore (IN)

(21) Appl. No.: 16/416,118

(22) Filed: May 17, 2019

(51) Int. Cl. G06F 16/2453; G06F 16/22; G06F 16/21; G06K 9/62

(52) U.S. Cl. CPC G06F 16/24549; G06K 9/6212; G06F 16/217; G06F 16/2282

(57) ABSTRACT

Various aspects of the subject technology relate to methods, systems, and machine-readable media for dynamic handling of skew to deliver consistent runtime performance for prepared queries. The method includes detecting skewed data in a table, the skewed data comprising a skewed value and a skewed column The method also includes formulating a first predicate between the skewed column and the skewed value. The method also includes formulating a second predicate between a dynamic parameter and the skewed value. The method also includes deriving a first query based on the first predicate. The method also includes deriving a second query based on the first query. The method also includes generating a query plan based on the first query, the second query, and the second predicate.

### BACKGROUND

In a Relational Database Management System (RDBMS), skew in the existing data is a factor that may affect the performance of prepared queries as user input varies. Specifically, runtime performance of a prepared query can exhibit huge variations with different user inputs if the data is skewed. Although database administrators (DBAs) attentively avoid skew in the data while designing schemas, real world scenarios are often unpredictable and certain tables in the database may end up having skewed data.

### BRIEF DESCRIPTION OF THE DRAWINGS

The following detailed description references the drawings, wherein:

FIGS. 1A-1C illustrate examples of query plans;

FIG. 2 illustrates an example query plan;

FIG. 3 illustrates an example flow diagram for dynamically removing skew; and

FIG. 4 is a block diagram illustrating an example computer system with which aspects of the subject technology may be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

Skewed data is highly problematic for many DBAs when it comes to performance tuning. If the data in the table is skewed, the runtime performance of prepared statements can vary when the user input varies. This makes turnaround time unpredictable for the applications using such prepared queries. Conventionally, DBAs attempt to avoid skew in data while designing schemas. However, DBAs are unable to predict every real-world scenario, which leads to certain tables in the database having skewed data.

This disclosure proposes a mechanism to manage skews dynamically for prepared statements when user input changes. For example, a database user may prepare a query once and execute it many times with different input values. The runtime performance of a prepared query can exhibit huge variations with different user inputs if the data is skewed. Aspects of the present disclosure ensure consistent runtime performance by dynamically managing the skew.

The disclosed methods, systems, and machine-readable media address a problem in traditional RDBMSs tied to computer technology, namely the technical problem of managing and removing skewed data. The disclosed methods, systems, and machine-readable media solve this technical problem by providing a solution also rooted in computer technology, namely, by detecting skew, formulating a skew busting predicate, deriving a query, and generating a query plan.

The disclosed subject technology further provides improvements to the functioning of the computer itself because it avoids the need for changing applications or recompiling a query with different user inputs to get optimal runtime performance.

According to an aspect, an exemplary RDBMS command may be:

DDL:
CREATE TABLE T (id int not null primary key,

cust_name varchar(32),
x int, --customer preference indicator

);

CREATE INDEX idx on T(x);

It may be assumed that column x has skewed data. It may be further assumed that value ‘10’ is skewed, and that it constitutes 98% of the total records in table T. A query to be prepared may be:

PREPARE q FROM SELECT * FROM T WHERE T.x=?;

Where ‘?’ is a dynamic parameter that may take different values from a user for each execution of the prepared query. The runtime performance of this query may vary noticeably if the data in the table ‘T’ is skewed. This variation can be avoided and the prepared query can provide optimal performance irrespective of user inputs using the technique described below.

This technique comprises four steps:

1) Skew detection

2) Formulation of skew busting predicate

3) Query derivation

4) Query Plan Generation

The steps listed above can be done by a query optimizer once the query optimizer is suitably modified. In other words, a DBA or database user need not do any modification to their query or application to receive results.

According to an aspect, the query optimizer may be included as a database management system (DBMS) component that analyzes Structured Query Language (SQL) queries and determines efficient execution mechanisms. The query optimizer may generate one or more query plans for each query, each of which may be a mechanism used to run a query.

### Skew Detection

According to an aspect, the first step is to detect whether there is skew. Skew will influence runtime performance when there is a predicate to enforce some condition between the skewed column and a dynamic parameter (DP). In order to detect the skew, a database optimizer collects the predicates (e.g., T.x=?) from the given query and identifies the columns (e.g., T.x) and associated dynamic parameters (e.g., ?) involved in those predicates. Once the list of columns and DPs are available, the next step is to get a data distribution pattern from histogram statistics of the table. From the histogram statistics, skew may be detected, if any. Other mechanisms like tuning parameters or optimizer hints can also be used to detect skew as well as skewed values. If any of the columns are found to have skew, those columns, associated dynamic parameters, and skewed value(s) are stored to prepare a skew busting predicate.

For example, in the exemplary RDBMS command above, it may be detected that column ‘x’ of table ‘T’ has skewed data, and the skewed value is ‘10’. As a result, column ‘x’, ‘?’, and value ‘10’ are stored for further processing.

### Formulation of Skew Busting Predicate

Once the column(s), DP(s) and value(s) are stored, a skew busting predicate may be created. According to an aspect, the skew busting predicate may be formed from two equality predicates. A type-1 equality predicate (e.g., a first predicate) may be between the skewed column and the value (e.g., skewed value). A type-2 equality predicate (e.g., a second predicate) may be between the dynamic parameter and the value. If there is more than one skewed value, one predicate may be formed for each value. These predicates are stored for later use.

Referring to the above exemplary RDBMS command, column ‘x’, ‘?’, and value ‘10’ were previously stored. These may now be utilized to set the type-1 predicate as “x=10” and the type-2 predicate as “?=10”.

### Query Derivation

Next, two (or more) queries may be derived from the original query. Once the new queries are derived, the original query may be discarded and the derived queries will be utilized for further processing. According to an aspect, the new queries may be derived based on three rules:

1) Append negated type-1 predicate to the original query using logical AND.

2) Replace the original predicate on the skewed column with the type-1 predicate.

3) Apply rules 1 and 2 to any additional type-1 predicates.

For example, suppose that the original query is:

SELECT * FROM T WHERE x=?

Applying rule 1, where the type-1 predicate is “x=10”, results in a first new query (e.g., a first query):

SELECT * FROM T WHERE x=? AND NOT (x=10);

Which can be written as:

SELECT * FROM T WHERE x=? AND x< >10;

Applying rule 2 results in a second new query (e.g., a second query), which is:

SELECT * FROM T WHERE x=10;

If there are additional type-1 predicates, then rule 3 may be followed to repeat rules 1 and 2. In this example, only one type-1 predicate exists, and so only rules 1 and 2 are applied. After applying the rules, the two new queries have been derived for further processing. The original query may be discarded at this point.

### Query Plan Generation

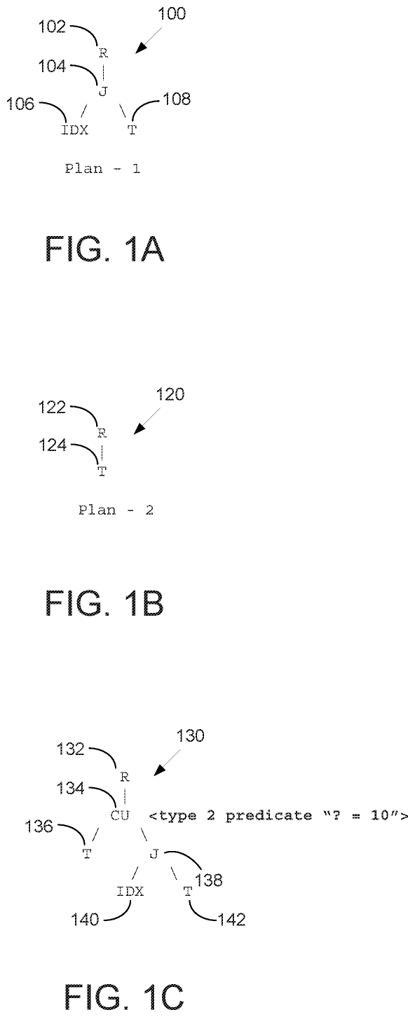

The optimizer may now optimize individual queries to generate a query plan for execution. Here, the first query may be optimized by considering that it need not read the skewed data. This plan may be referred to as “Plan 1” and it may be assumed the optimizer chooses an index join access path for this query plan. The pictorial representation of Plan 1 is shown in FIG. 1A.

Referring to FIG. 1A, Plan 1 100 may include a root node 102, a join node 104, an index node 106, and a table node 108. For example, the join node 104 may be joining the index node 106 and the table node 108.

The optimizer may then optimize the second query. According to an aspect of the present disclosure, the second query may be optimized by considering it will read only the skewed data. As a result, the optimizer may choose a full table scan as the access path for this query. This plan may be referred to as “Plan 2” as shown in FIG. 1B. As illustrated in FIG. 1B, Plan 2 120 may be a full table scan that includes a root node 122 and a table node 124.

Plan 1 and Plan 2 may then be connected in such a way that an execution engine may dynamically decide which plan to execute based on user input. This may achieved by utilizing a special relational expression referred to as a Conditional Union (CU). For example, given that UNION is a standard relational expression, CU may be an enhanced version of UNION. According to an aspect, CU may include a conditional expression to be evaluated and, based on the condition, it will execute either a left or right child. The CU operator will not execute both the child nodes, unlike the traditional UNION operator. In an implementation, CU may execute the left child if the conditional expression evaluates to TRUE, and it may execute the right child otherwise.

The following steps list the optimizer tasks used to generate the final query plan by using the CU node:

1) Create a CU node.

2) Set the type-2 predicate as the conditional expression for the newly created CU node.

3) Set Plan 2 as left child of CU node.

4) Set Plan 1 as right child of the CU node.

5) Set a root node on top of the CU node.

Using the above five steps, the final query plan may be derived, as shown in FIG. 1C. According to an aspect, FIG. 1C illustrates an exemplary final query plan 130 that is based on Plan 1 100 and Plan 2 120. The final query plan (e.g., the query plan) may include a root node 132, a CU node 134, a first table node 136, a join node 138, an index node 140, and a second table node 142. For example, the CU node 134 may connect Plan 1 with Plan 2. As shown, Plan 1 includes the join node 138, the index node 140, and the second table node 142. Plan 2 includes the first table node 136. Both Plan 1 and Plan 2 share the same root node 132.

As illustrated, the type-2 predicate (e.g., “?=10”) may be the conditional expression for the CU node 134. The final query plan 130 dynamically determines which child to execute based on user input, and thus provides the most optimal runtime performance.

According to additional aspects, query derivation may result in more than two queries if there is more than one skewed value. The same is true if the query has more than one table having at least one skewed value. In such cases, CU nodes may be utilized to chain them appropriately with conditional expressions connecting type-2 predicates.

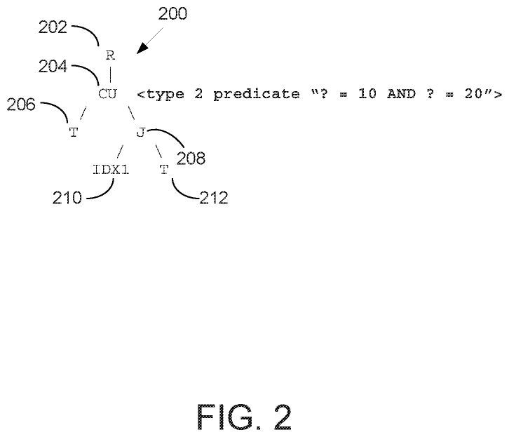

FIG. 2 illustrates another exemplary query plan 200 generated when there are multiple tables with skewed values. For example, an RDBMS command may be:

CREATE TABLE T (id int not null primary key,

cust_name varchar(32),
x int, --customer preference indicator
y int — language preference

);

CREATE INDEX idx1 on T(x);

It may be assumed that column x and y have skewed data. Column x may have value ‘10’ as skewed, and for column y, value ‘20’ may be skewed. These skews may constitute 98% of the total records in table T.

Applying the above-described steps 1-4, the query to be prepared may be:

PREPARE q FROM SELECT * FROM T WHERE T.x=? AND y=?;

A type-1 predicate for skewed column x (e.g., value ‘10’) may be:

x=10

A type-1 predicate for skewed column y (e.g., value ‘20’) may be:

y=20

A type-2 predicate for column x (e.g., for “x=?”) may be:

?=10

A type-2 predicate for column y (e.g., for “y=?”) may be:

?=20

Applying rule 1 results in:

SELECT * FROM T WHERE x=? AND NOT (x=10 AND y=20);

Applying rule 2 results in:

SELECT * FROM T WHERE x=10 AND y=20;

The final query plan 200 may be generated by connecting two query plans using a CU node 204. For example, the final query plan 200 may include a root node 202, the CU node 204, a first table node 206, a join node 208, an index node 210, and a second table node 212.

According to an aspect, a first query plan may include the root node 202 and the first table node 206. A second query plan may include the root node 202, the join node 208, the index node 210, and the second table node 212. The type-2 predicates (e.g., “?=10” and “?=20”) may be joined by AND as the conditional expression for the CU node 204. According to other implementations, the type-2 predicates may alternatively be joined by OR.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

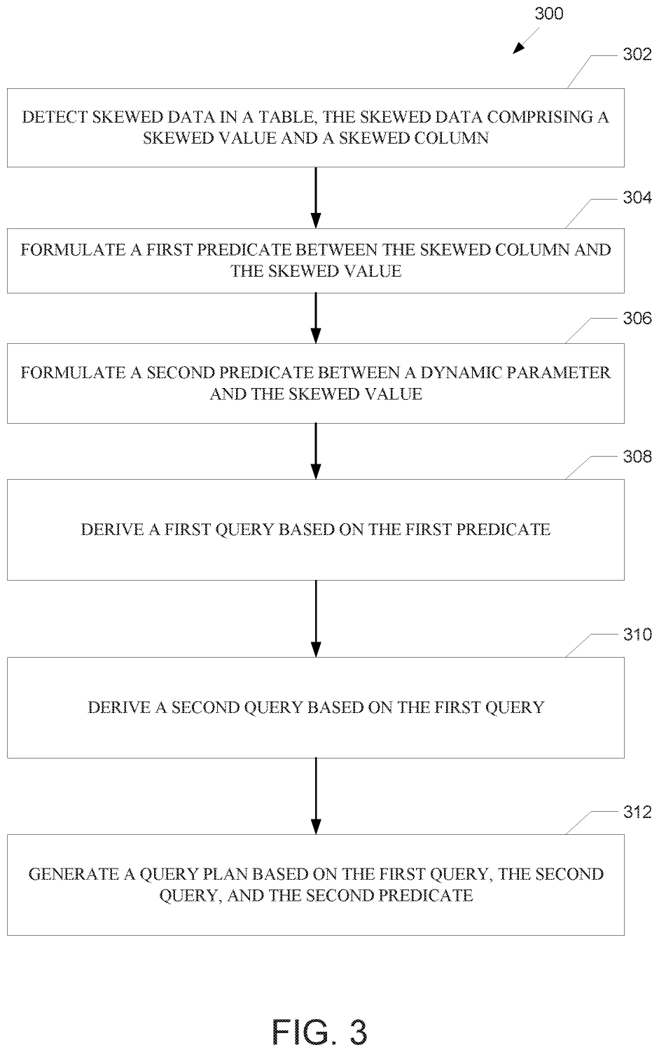

FIG. 3 illustrates an example flow diagram (e.g., process 300) for dynamically removing skew. For explanatory purposes, the example process 300 is described herein with reference to FIGS. 1A-1C. Further, for explanatory purposes, the blocks of the example process 300 are described herein as occurring in serial, or linearly. However, multiple blocks of the example process 300 may occur in parallel. In addition, the blocks of the example process 300 need not be performed in the order shown and/or one or more of the blocks of the example process 300 need not be performed. For purposes of explanation of the subject technology, the process 300 will be discussed in reference to FIGS. 1A-1C.

At block 302, skewed data is detected in a table. The skewed data may include a skewed value and a skewed column At block 304, a first predicate is formulated between the skewed column and the skewed value. At block 306, a second predicate is formulated between a dynamic parameter and the skewed value. At block 308, a first query is derived based on the first predicate. At block 310 a second query is derived based on the first query. At block 312, a query plan is generated based on the first query, the second query, and the second predicate.

In an implementation, a query optimizer may detect that there is skewed data in a table. For example, the skewed data may include at least one skewed value and at least one skewed column. A first predicate may be formulated between the skewed column and the skewed value. A second predicate may be formulated between a dynamic parameter and the skewed value. A first query may be derived based on the first predicate. For example a first query plan (e.g., Plan 1, as shown in FIG. 1A) may be generated. A second query may be derived based on the first query. For example, a second query plan (e.g., Plan 2, as shown in FIG. 1B) may be generated. A final query plan 130 may then be generated based on the first query, the second query, and the second predicate. The final query plan 130 may include a type-2 predicate as a CU conditional expression.

According to an aspect, the query optimizer may be included as a database management system (DBMS) component that analyzes Structured Query Language (SQL) queries and determines efficient execution mechanisms. The query optimizer may generate one or more query plans for each query, each of which may be a mechanism used to run a query.

According to an aspect, detecting the skewed data may include collecting a plurality of predicates from a given query, and identifying columns and dynamic parameters associated with the plurality of predicates.

According to an aspect, the process 300 further includes generating a data distribution pattern from histogram statistics of the table, and identifying the skewed data from the histogram statistics based on the data distribution pattern.

According to an aspect, deriving the first query may include negating the first predicate to generate a negated first predicate, and appending the negated first predicate to an original query with a logical AND.

According to an aspect, deriving the second query may include replacing an original predicate on the skewed column with the first predicate. According to an aspect, the process 300 further includes setting the second predicate as a conditional expression for the conditional union.

According to an aspect, generating the query plan may include generating a first optimized query plan from the first query, generating a second optimized query plan from the second query, and connecting the first optimized query plan with the second optimized query plan with a conditional union.

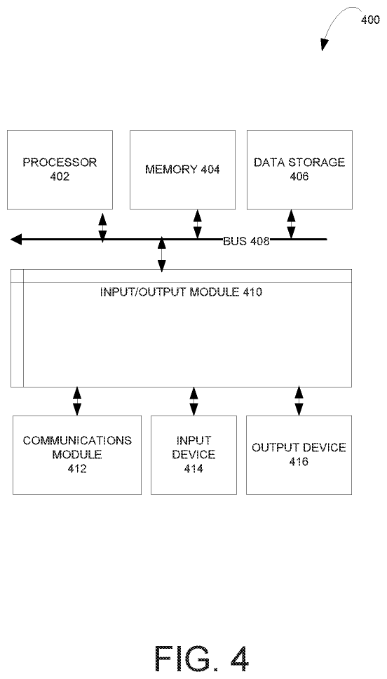

FIG. 4 is a block diagram illustrating an exemplary computer system 400 with which aspects of the subject technology may be implemented. In certain aspects, the computer system 400 may be implemented using hardware or a combination of software and hardware, either in a dedicated server, integrated into another entity, or distributed across multiple entities.

Computer system 400 includes a bus 408 or other communication mechanism for communicating information, and a processor 402 coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, for example, code that constitutes processor firmware, a protocol stack, a database management system, an operating system, or a combination of one or more of them stored in an included memory 404, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer-readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multi-paradigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Exemplary input/output modules 410 include data ports such as USB ports. The input/output module 410 is configured to connect to a communications module 412. Exemplary communications modules 412 include networking interface cards, such as Ethernet cards and modems. In certain aspects, the input/output module 410 is configured to connect to a plurality of devices, such as an input device 414 and/or an output device 416. Exemplary input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 416 include display devices such as an LCD (liquid crystal display) monitor, for displaying information to the user.

According to one aspect of the present disclosure, the devices and systems can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in the main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., such as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium (e.g., a non-transitory machine-readable storage medium encoded with instructions executable by at least one hardware processor of a network device) can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A method, comprising:
detecting skewed data in a table, the skewed data comprising a skewed value and a skewed column;
formulating a first predicate between the skewed column and the skewed value;
formulating a second predicate between a dynamic parameter and the skewed value;
deriving a first query based on the first predicate;
deriving a second query based on the first query; and
generating a query plan based on the first query, the second query, and the second predicate.

2. The method of claim 1, wherein detecting the skewed data comprises:
collecting a plurality of predicates from a given query; and
identifying columns and dynamic parameters associated with the plurality of predicates.

3. The method of claim 2, further comprising:
generating a data distribution pattern from histogram statistics of the table; and
identifying the skewed data from the histogram statistics based on the data distribution pattern.

4. The method of claim 1, wherein deriving the first query comprises:
negating the first predicate to generate a negated first predicate; and
appending the negated first predicate to an original query with a logical AND.

5. The method of claim 1, wherein deriving the second query comprises:
replacing an original predicate on the skewed column with the first predicate.

6. The method of claim 1, wherein generating the query plan comprises:
generating a first optimized query plan from the first query;
generating a second optimized query plan from the second query; and
connecting the first optimized query plan with the second optimized query plan with a conditional union.

7. The method of claim 6, further comprising:
setting the second predicate as a conditional expression for the conditional union.

8. A system, comprising:
a memory; and
a processor executing instructions from the memory to:
detect skewed data in a table, the skewed data comprising a skewed value and a skewed column;
formulate a first predicate between the skewed column and the skewed value;
formulate a second predicate between a dynamic parameter and the skewed value;
derive a first query based on the first predicate;
derive a second query based on the first query; and
generate a query plan based on the first query, the second query, and the second predicate.

9. The system of claim 8, wherein the processor further executes the instructions from the memory to:
collect a plurality of predicates from a given query; and
identify columns and dynamic parameters associated with the plurality of predicates.

10. The system of claim 9, wherein the processor further executes the instructions from the memory to:
generate a data distribution pattern from histogram statistics of the table; and
identify the skewed data from the histogram statistics based on the data distribution pattern.

11. The system of claim 8, wherein the processor further executes the instructions from the memory to:
negate the first predicate to generate a negated first predicate; and
append the negated first predicate to an original query with a logical AND.

12. The system of claim 8, wherein the processor further executes the instructions from the memory to:
replace an original predicate on the skewed column with the first predicate.

13. The system of claim 8, wherein the processor further executes the instructions from the memory to:
generate a first optimized query plan from the first query;
generate a second optimized query plan from the second query; and
connect the first optimized query plan with the second optimized query plan with a conditional union.

14. The system of claim 13, wherein the processor further executes the instructions from the memory to:
set the second predicate as a conditional expression for the conditional union.

15. A non-transitory machine-readable storage medium encoded with instructions executable by at least one hardware processor of a network device, the non-transitory machine-readable storage medium comprising instructions to:
detect skewed data in a table, the skewed data comprising a skewed value and a skewed column;
formulate a first predicate between the skewed column and the skewed value;
formulate a second predicate between a dynamic parameter and the skewed value;
derive a first query based on the first predicate;
derive a second query based on the first query; and
generate a query plan based on the first query, the second query, and the second predicate.

16. The non-transitory machine-readable storage medium of claim 15, further comprising instructions to:
collect a plurality of predicates from a given query; and
identify columns and dynamic parameters associated with the plurality of predicates.

17. The non-transitory machine-readable storage medium of claim 16, further comprising instructions to:
generate a data distribution pattern from histogram statistics of the table; and
identify the skewed data from the histogram statistics based on the data distribution pattern.

18. The non-transitory machine-readable storage medium of claim 15, further comprising instructions to:
negate the first predicate to generate a negated first predicate; and
append the negated first predicate to an original query with a logical AND.

19. The non-transitory machine-readable storage medium of claim 15, further comprising instructions to:
replace an original predicate on the skewed column with the first predicate.

20. The non-transitory machine-readable storage medium of claim 15, further comprising instructions to:
generate a first optimized query plan from the first query;
generate a second optimized query plan from the second query;
connect the first optimized query plan with the second optimized query plan with a conditional union; and
set the second predicate as a conditional expression for the conditional union.
